(19) United States
(12) Patent Application Publication
(10) Pub. No.: US 2026/0057440 A1
(43) Pub. Date: Feb. 26, 2026

(54) NETWORKED EVENT RESPONSE SYSTEM

(71) Applicant: PAX Markets, Inc., Redwood City, CA (US)

(72) Inventor: John Peter STEVENSON, Redwood City, CA (US)

(21) Appl. No.: 19/314,513

(22) Filed: Aug. 29, 2025

Related U.S. Application Data
(63) Continuation of application No. PCT/US2025/042861, filed on Aug. 20, 2025.
(60) Provisional application No. 63/685,023, filed on Aug. 20, 2024.

(51) Int. Cl. G06Q 40/04

(52) U.S. Cl. CPC G06Q 40/042

(57) ABSTRACT

A networked system for processing event response pairs across multiple locations includes a memory storing a plurality of event response pairs, each comprising an event predicate and an associated underlying order; a network interface receiving a continuous stream of trigger information entries from internal and external sources; and a processor coupled to the memory and network interface. The processor evaluates each received trigger information entry against the stored event predicates to identify one or more matches, prepares the associated underlying orders for transmission to specified destinations, sequences the prepared underlying orders based on a multi-response handling algorithm, and transmits the sequenced underlying orders via the network interface to the specified destinations.

### CROSS-REFERENCE TO RELATED APPLICATIONS

This application is a continuation of International Application No. PCT/US2025/042861 filed on Aug. 20, 2025, which claims the priority benefit of U.S. Provisional Patent Application No. 63/685,023 filed on Aug. 20, 2024, the contents of both of which are incorporated herein by reference in their entireties.

### TECHNICAL FIELD

The present disclosure relates generally to networked systems and methods for processing event response pairs across multiple locations.

### BACKGROUND

Electronic trading systems have become increasingly prevalent in financial markets, allowing participants to execute trades across multiple venues and asset classes. These systems typically process large volumes of market data and orders in real-time, requiring sophisticated infrastructure to handle the high-frequency nature of modern trading.

Many trading venues now offer electronic interfaces that allow market participants to submit orders and receive market data updates. This has led to the development of automated trading strategies that aim to capitalize on price discrepancies or market inefficiencies across different venues. However, implementing such strategies often requires complex systems to monitor multiple data feeds, evaluate trading signals, and route orders to the appropriate destinations.

The speed at which market data is processed and trading decisions are made has become a key factor in electronic trading. Latency-sensitive strategies rely on rapidly analyzing incoming information and submitting orders before competing participants. This has driven demand for low-latency infrastructure and optimized software implementations to minimize processing times.

As trading has become more automated, there is an increasing need for robust systems to manage event-driven order flow across distributed trading environments. Effective solutions must be able to handle high message volumes, evaluate complex order conditions, and route orders to multiple venues while maintaining consistency and fault tolerance.

Additionally, regulatory requirements around best execution and trade reporting have increased the importance of comprehensive audit trails and market data management. Trading systems must now capture and store detailed information about order lifecycles and market conditions to demonstrate compliance and enable post-trade analysis.

The growth of electronic trading has also led to new challenges around risk management and market stability. Circuit breakers, order throttling, and other safeguards have been implemented by exchanges and regulators to mitigate the potential for extreme price movements or disruptive trading behavior.

As markets continue to evolve, there remains an ongoing need for improved trading infrastructure that can adapt to changing market structures and participant demands. Addressing the technical challenges around data processing, order routing, and risk controls remains an active area of development in electronic trading systems.

### SUMMARY

In some embodiments, a system includes a memory configured to store a plurality of event response pairs, each event response pair including an event predicate and an associated underlying order; a network interface configured to receive a continuous stream of trigger information entries from internal and external network sources; and a processor communicatively coupled to the memory and the network interface, the processor configured to: evaluate each received trigger information entry against each event predicate to identify one or more matched predicates, for each of the one or more matched predicates, prepare the associated underlying order for transmission over a network to a specified destination, if multiple different responses are triggered simultaneously, sequence the associated underlying order based on a multi-response handling algorithm for network transmission, and transmit, via the network interface, the associated underlying order to the specified destination based on the sequence.

In some embodiments, each event predicate includes a trigger asset field and one more additional fields including at least one of: an event type field, an event book side field, a minimum price field, a maximum price field, a minimum quantity field, a maximum quantity field, and an operation code field including programming instructions.

In some embodiments, the processor is further configured to generate and publish a unified market structure enriched market data message, wherein the unified market structure enriched market data message combines book updates and trade publication into a single publication.

In some embodiments, the unified market structure enriched market data message further combines new orders, order modifications, order cancellations, and top-of-book information.

In some embodiments, publishing the unified market structure enriched market data message includes publishing to a single data stream configured to recreate a complete system-state based on a prior snapshot system-state.

In some embodiments, the processor is further configured to modify the stored event response pairs to remove or update processed event responses.

In some embodiments the multi-response handling algorithm prioritizes orders based on at least one of: time of predicate match, order size, or price parameters.

In some embodiments, the multi-response handling algorithm includes payment-based prioritization.

In some embodiments, the specified destination includes a trading venue.

In some embodiments, a method includes storing, by a processor, a plurality of event response pairs, each event response pair including an event predicate and an associated underlying order; receiving, by the processor, a continuous stream of trigger information entries from internal and external network sources; evaluating, by the processor, each received trigger information entry against each event predicate to identify one or more matched predicates; for each of the one or more matched predicates, preparing, by the processor, the associated underlying order for transmission over a network to a specified destination; if multiple different responses are triggered simultaneously, sequencing, by the processor, the associated underlying order based on a multi-response handling algorithm for network transmission; and transmitting, via the network interface, the associated underlying order to the specified destination based on the sequence.

In some embodiments, each event predicate includes a trigger asset field and one more additional fields including at least one of: an event type field, an event book side field, a minimum price field, a maximum price field, a minimum quantity field, a maximum quantity field, and an operation code field including programming instructions.

In some embodiments, the method further includes generating and publishing a unified market structure enriched market data message, wherein the unified market structure enriched market data message combines book updates and trade publication into a single publication.

In some embodiments, the unified market structure enriched market data message further combines new orders, order modifications, order cancellations, and top-of-book information.

In some embodiments, publishing the unified market structure enriched market data message includes publishing to a single data stream configured to recreate a complete system-state based on a prior snapshot system-state.

In some embodiments, the method further includes modifying the stored event response pairs to remove or update processed event responses.

In some embodiments, the multi-response handling algorithm prioritizes orders based on at least one of: time of predicate match, order size, or price parameters.

In some embodiments, the multi-response handling algorithm includes payment-based prioritization.

In some embodiments, the specified destination includes a trading venue.

In some embodiments, a non-transitory computer-readable medium storing instructions that, when executed by a processor, cause the processor to perform operations including storing a plurality of event response pairs, each event response pair including an event predicate and an associated underlying order; receiving a continuous stream of trigger information entries from internal and external network sources; evaluating each received trigger information entry against each event predicate to identify one or more matched predicates; for each of the one or more matched predicates, preparing the associated underlying order for transmission over a network to a specified destination; if multiple different responses are triggered simultaneously, sequencing the associated underlying order based on a multi-response handling algorithm for network transmission; and transmitting the associated underlying order to the specified destination based on the sequence.

In some embodiments, the operations further include generating and publishing a unified market structure enriched market data message, wherein the unified market structure enriched market data message combines book updates and trade publication into a single publication.

Further features of the present disclosure, as well as the structure and operation of various embodiments, are described in detail below with reference to the accompanying drawings. It is noted that the present disclosure is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 depicts an event response pair structure in accordance with an embodiment.

FIG. 2 depicts an illustrative predicate structure with multiple parameter fields in accordance with an embodiment.

FIG. 3 depicts a block diagram of a venue hosting inter-venue event response technology in accordance with an embodiment.

FIG. 4 depicts an illustrative system for processing market participant orders and event responses in accordance with an embodiment.

FIG. 5 depicts a flow diagram for an exemplary method of processing event response pairs and transmitting orders in accordance with an embodiment.

FIG. 6 depicts a flow diagram for an illustrative method of post-processing market data and event pairs in accordance with an embodiment.

FIG. 7 depicts an example of an unified market structure enriched market data message in accordance with an embodiment.

FIG. 8 depicts an exemplary computer system architecture in accordance with an embodiment.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

This disclosure is not limited to the particular systems, devices and methods described, as these may vary. The terminology used in the description is for the purpose of describing the particular versions or embodiments only and is not intended to limit the scope.

### Overview

In the context of electronic trading (e.g. trading stocks, other securities, derivatives, cryptocurrencies, cryptographic tokens, or other assets) there may be multiple venues that trade the same stock or underlying asset or multiple venues that trade similar or highly correlated assets. Thus, there are many financial exchanges, and the assets traded on those exchanges may be fungible (e.g. two different exchanges that both offer trading in bitcoin) or the assets trading on those exchanges may be highly correlated (e.g. two different exchanges trading different contracts for the future delivery of a barrel of oil). As a result, events and market data published by one exchange (the “local” venue) may lead to traders submitting orders to a different exchange (a “remote” venue). This style of trading may be referred to as arbitrage, or latency arbitrage, insomuch as it may appear that a risk-free profitable trade exists at the remote venue because the quotes posted at the remote venue have not been updated to reflect the new pricing information that has been revealed by market data published at the local venue (or vice versa).

Such inter-venue trading opportunities may be identified and present the opportunity for low-risk profitable trades. As such, multiple market participants may attempt to take the profitable opportunity at the remote venue. Because exchanges may implement price-time matching (e.g., where orders that arrive at the venue first are processed first) participants attempting to capture the profit opportunity may need to react swiftly. Otherwise, other traders may come into the market to take that opportunity which by its very definition is limited in its scale and cannot accommodate an arbitrary or large “investment” interest. As a result, these inter-venue trading opportunities are time-sensitive and limited in scale.

Thus, traders attempting to profit by these opportunities seek to minimize their reaction time latency (e.g., the amount of time they spend making a decision based on new information made available by the local venue) and their network latency (e.g., the amount of time spent moving information from the local venue to trading logic and from trading logic to the remote venue). The trading system with the lowest overall latency will have an advantage in that its orders will be more likely to capture any profitable inter-venue trading opportunities because its orders will arrive at the remote venue first.

This disclosure relates to a networked system and method for processing event response pairs across multiple locations in electronic trading environments. The system comprises a memory for storing event response pairs, each including an event predicate and an associated underlying order, and a network interface for receiving a continuous stream of trigger information entries from various sources. A processor evaluates the received trigger information against stored event predicates to identify matches, e.g. when a trigger datum or data meets the predicate requirements. When a match occurs, the system prepares the associated underlying order for transmission to a specified remote destination, such as a trading venue.

Cryptographic currencies and other tokens are traded at various venues. Such venues include centralized (CeFi) exchanges which enable high speed trading on behalf of participants, but do not require validation by a proof-of-work or proof-of-stake protocol, and decentralized (DeFi) exchanges (e.g., smart contracts, pools, liquidity pools, or protocols) which enable trading that is validated and memorialized by a public consensus such as proof-of-work or proof-of-stake but may process transactions at a slower rate than that provided by a centralized exchange.

As a result of information aggregated at and published by a CeFi exchange, a trader may send an order or transaction to a different CeFi exchange or to a DeFi exchange. The conjugate scenario exists, where as a result of information aggregated by and published in a block-chain, a trader may send an order or transaction to a CeFi or to a DeFi exchange.

The system employs a multi-response handling algorithm to sequence and prioritize the transmission of matched orders. This may include considering factors such as the time of predicate match, order size, or price parameters. The system also includes features for logging execution of event response pairs, generating and publishing unified market structure enriched market data messages, and modifying stored event response pairs to remove or update processed responses. By efficiently processing complex event conditions and routing orders across distributed trading environments, the system aims to address challenges in high-frequency electronic trading, including latency management, regulatory compliance, and adaptation to evolving market structures.

### Event Response Examples

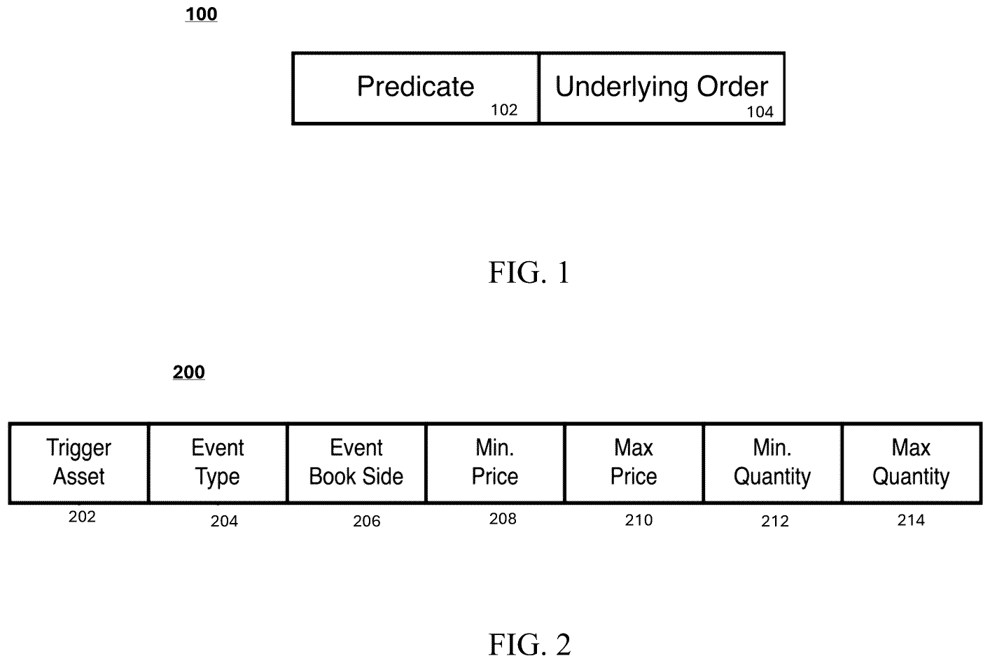

FIG. 1 illustrates an event response pair structure. The event response pair structure may include a predicate field 102 and an underlying order field 104.

The predicate field 102 may contain criteria or conditions that, when met, trigger a response in the event response system. In some cases, the predicate field 102 may specify parameters such as asset type, price thresholds, quantity thresholds, or other market conditions that need to be satisfied for the event response to be activated.

The event predicate may be programmable by users to define specific conditions that trigger the execution of associated underlying orders. In some cases, users may configure predicates to respond to various market events, including price movements, volume changes, or other market conditions. The predicate may include programmable parameters that allow users to specify trigger criteria such as asset identifiers, price thresholds, quantity ranges, and event types. Users may program predicates to monitor specific market conditions and automatically submit and/or execute orders when those conditions are met, enabling automated trading strategies without requiring continuous manual intervention.

The programmable predicate may be configured to operate in different modes depending on user requirements. In some aspects, a predicate may be set to trigger only once when a specified condition is met, after which it may be automatically removed or deactivated from the system. Alternatively, the predicate may be configured to trigger repeatedly whenever the specified event occurs, such as when a market value changes by a predetermined amount or when trading volume exceeds a certain threshold. This flexibility allows users to implement both single-execution strategies and ongoing monitoring strategies that respond to recurring market conditions. The system may provide users with programming interfaces or configuration tools that enable them to define these triggering behaviors and specify whether predicates should remain active after execution or be automatically disabled.

The underlying order field 104 may contain information about the order to be executed when the conditions specified in the predicate field 102 are met. In some cases, the underlying order field 104 may include details such as the asset to be traded, the quantity, the price, and the destination venue for the order.

The event response pair structure may be stored in a data structure within a memory of the event response system. The system may receive a plurality of event response pairs, each comprising an event predicate and an associated underlying order. These event response pairs may be stored in the memory, allowing the system to efficiently evaluate incoming market data against the stored predicates.

In some embodiments, the memory includes a database to efficiently store and manage the event response pairs. In some cases, the database may be structured as a relational database with tables for predicates and underlying orders, linked by unique identifiers. Alternatively, the database may utilize a NoSQL structure, such as a document-oriented database, allowing for flexible schema design and rapid retrieval of event response pairs. The database may also implement indexing strategies to optimize query performance, particularly for high-frequency predicate matching operations. In some aspects, the database structure may incorporate a hybrid approach, combining elements of relational and non-relational models to balance data integrity with scalability. The database may support distributed storage across multiple nodes to enhance fault tolerance and enable parallel processing of incoming trigger information.

In some aspects, the memory may be managed directly by special purpose hardware. It may be implemented in hardware (e.g. in on-chip memory), or by directly accessing a hardware memory device such as static random access memory (SRAM) or dynamic random-access memory (DRAM).

The memory may also be implemented by a software data structure of various kinds, e.g. as a hash table, as a map, as a FIFO, as a queue, as a multi-map, or as a list.

The relationship between the predicate field 102 and the underlying order field 104 may be crucial to the functioning of the event response system. When market conditions or other relevant data match the criteria specified in the predicate field 102, the system may retrieve the associated underlying order from the underlying order field 104 and prepare it to be submitted or to be executed.

In some cases, the event response system may continuously monitor incoming data streams and compare them against the stored predicates. When a match occurs, the system may access the corresponding underlying order and initiate the appropriate trading action, e.g. submitting the order or executing the order.

FIG. 2 illustrates a block diagram showing multiple fields that may be included in the predicate field 102. These fields may provide specific criteria for triggering an event response.

A trigger asset field 202 may contain information identifying the asset of interest for the event predicate. In some cases, the trigger asset field 202 may specify a particular stock symbol, cryptocurrency, or other tradable asset. The trigger asset 202 may differ from the asset targeted by the underlying order 104.

An event type field 204 may specify the type of event that the predicate is designed to detect. In some cases, the event type field 204 may indicate whether the predicate is looking for a price change, volume change, or other market event. The event type field 204 may indicate whether liquidity is added or removed from the order book. The event type field 204 may further define the manner in which the liquidity is removed (e.g., execution or size-down/cancellation).

An event book side field 206 may indicate which side of the order book the predicate is monitoring. In some cases, the event book side field 206 may specify whether the predicate is focused on bids, asks, or both.

A minimum price field 208 and a maximum price field 210 may define a price range for the event predicate. In some cases, the minimum price field 208 may set a lower bound for the price condition, while the maximum price field 210 may set an upper bound.

A minimum quantity field 212 and a maximum quantity field 214 may define a quantity range for the event predicate. In some cases, the minimum quantity field 212 may specify the smallest quantity that will trigger the predicate, while the maximum quantity field 214 may specify the largest quantity.

The combination of these fields within the predicate field 102 may allow for highly specific event conditions to be defined. When all the criteria specified in these fields are met by incoming market data, the event response system may trigger the associated underlying order from the underlying order field 104.

In some cases, not all fields may be required for every predicate. The event response system may allow for flexible predicate structures where certain fields may be left unspecified or set to default values.

The predicate fields may store their match values as absolute values or as deltas, e.g. changes relative to the current market state. For example, a predicate may trigger based on a certain price (e.g. BTC sells for $100K) or based on a certain change in price (e.g. BTC price increased by $1K).

The predicate may be generalized to store a state and evaluate its condition based on its stored state. The predicate may include conjunctive, disjunctive, or mathematical operators to combine and compare different elements in its parameters.

The predicate structure illustrated in FIG. 2 may enable the event response system to efficiently evaluate incoming market data against a wide range of potential event conditions. By storing these predicates in a structured format, the system may quickly determine when market conditions match the criteria specified in one or more event response pairs.

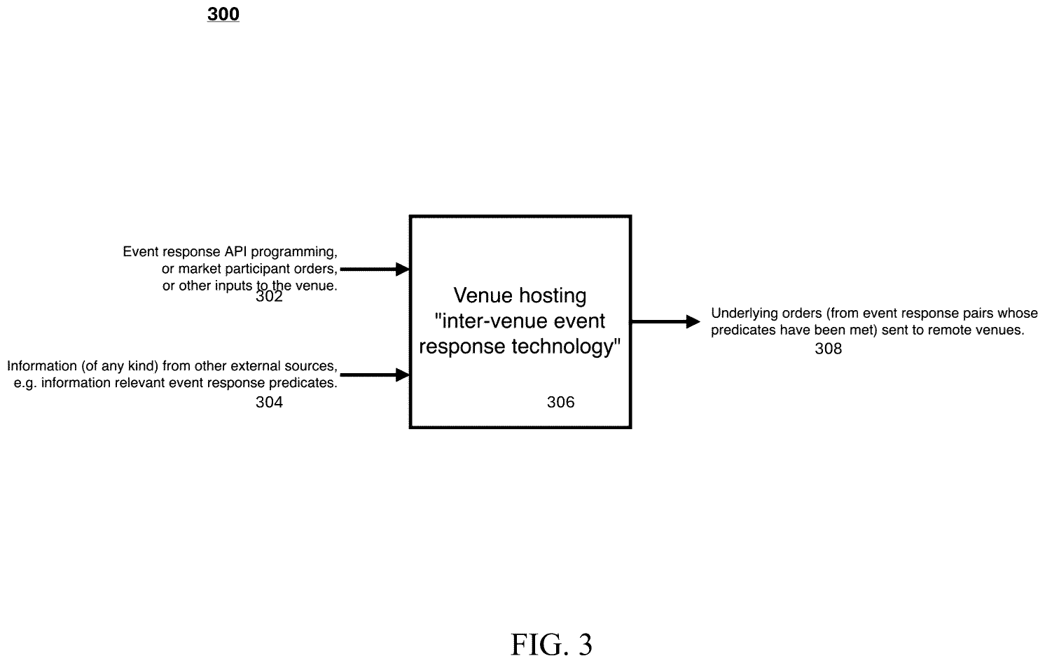

FIG. 3 illustrates a block diagram of a venue hosting inter-venue event response technology. The system receives information and generates responses through multiple components.

The event response system may be configured to handle trigger scenarios based on the source of trigger information and the destination of the resulting response. In some embodiments, trigger information may originate from local sources within the host venue or from remote external sources, while the corresponding response may be directed to either local destinations within the same venue or to remote destinations at different venues. This creates four distinct operational modes: local trigger information generating local responses, local trigger information generating remote responses, remote trigger information generating local responses, and remote trigger information generating remote responses; the latter of these (“remote” x “remote”) not requiring that a local venue be implemented. Each operational mode may have different latency characteristics and processing requirements. For example, when both the trigger source and response destination are remote (remote-to-remote scenarios), the system may implement specialized low-latency trigger services to minimize processing delays and optimize the speed of cross-venue arbitrage opportunities. The system may be configured to support any combination of these trigger source and response destination pairings, allowing market participants to program event response pairs that can react to information from any source and direct orders to any available destination venue.

For responses sent to remote venues, the system may authenticate or prove authenticity on behalf of the system itself or on behalf of system clients or users. To do so, the system may incorporate signing keys, private keys, shared secrets, authentication tokens, API access tokens, or hold the underlying event response as a pre-signed message.

System inputs may include an event response input 302 that may include event response API programming or the market participant underlying orders to be embedded with event response programming. These inputs 302 include communications directly between the local venue and participants.

System inputs may include an external information input 304 that may include information from other external sources. In some cases, the external information input 304 may include data relevant to event response predicates. The external information input 304 may include various types of data from remote sources that may be relevant to event response processing. In some cases, the external information input 304 may receive order information from remote trading venues, including order book updates, trade executions, and price movements from other exchanges or market centers. The external information input 304 may also include market data feeds, news events, economic indicators, or other financial information that may influence trading decisions. Additionally, the external information input 304 may include inter-venue communications, such as notifications of order fills or cancellations from partner exchanges, enabling the system to maintain awareness of trading activity across multiple venues.

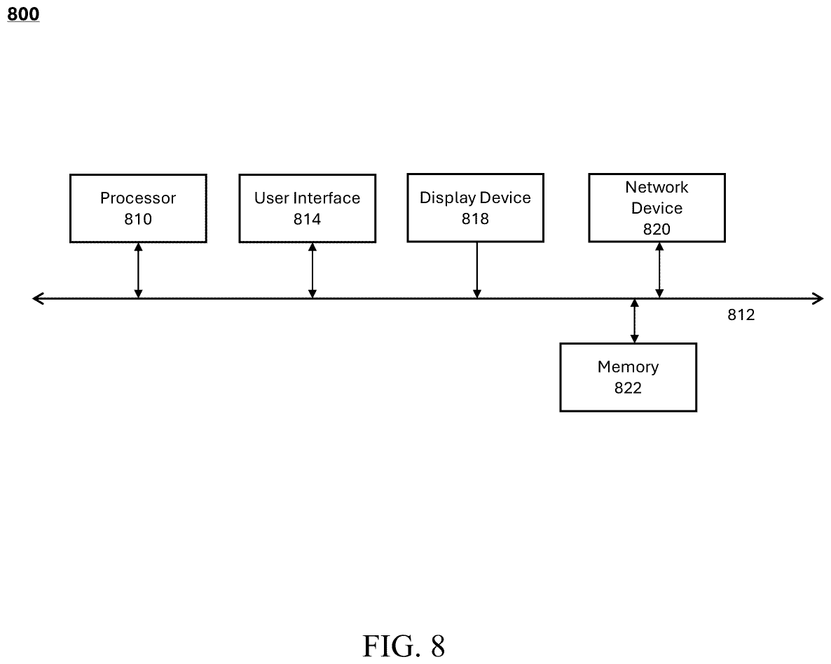

An event response host 306 may process inputs from both the event response input 302 and external information input 304. The event response host 306 may evaluate the received information against stored event response predicates. In some cases, the event response host 306 may be implemented in a software program that runs on a computing device (e.g., the computing device of FIG. 8).

The event response host 306 may fully integrate network switch technology. In some cases, the event response host 306 may implement pass-through inter-venue event responses. The event response venue 306 may be implemented as hardware or as a hardware software codesign, including ASIC, FPGA, or other silicon or electronic device implementation.

The event response host 306 may continuously evaluate predicates by maintaining an active monitoring process that compares incoming information from both the event response input 302 and external information input 304 against the stored event response predicates. In some cases, the host 306 may implement a real-time evaluation engine that processes each incoming data element as it arrives, checking it against all relevant predicates in the system's memory. The relevant predicates may be checked in parallel (e.g. all relevant predicates checked simultaneously) or they may be checked sequentially, or in some combination (e.g. several predicates checked in parallel, followed by several more checked in parallel). The evaluation process may involve parsing the incoming information to extract relevant parameters such as asset identifiers, price levels, quantities, and event types, then matching these parameters against the corresponding fields in the stored predicates.

The event response host 306 may employ various optimization techniques to enhance the speed and efficiency of predicate evaluation. In some cases, the host 306 may implement indexing mechanisms that organize predicates based on trigger assets or other key parameters, allowing for rapid filtering of relevant predicates before detailed evaluation. The host 306 may also utilize caching strategies to store frequently accessed predicates in high-speed memory, reducing lookup times during the evaluation process. In some aspects, the host 306 may implement threshold-based evaluation where predicates are pre-filtered based on basic criteria before more complex matching operations are performed. The continuous evaluation process may be designed to minimize latency while maintaining accuracy, ensuring that predicate matches are identified and processed as quickly as possible to enable timely order execution.

In some cases, the event response host 306 may be implemented for cryptographically signed underlying orders. The event response host 306 may be implemented with a fully integrated network switch responsible for aggregating and serializing various messages. The functionality of the event response host 306 may be split between various hardware and software components.

A response output 308 may comprise underlying orders that are sent to remote venues. The response output 308 may represent orders whose predicates have been satisfied based on the evaluation of inputs received through the event response input 302 and external information input 304.

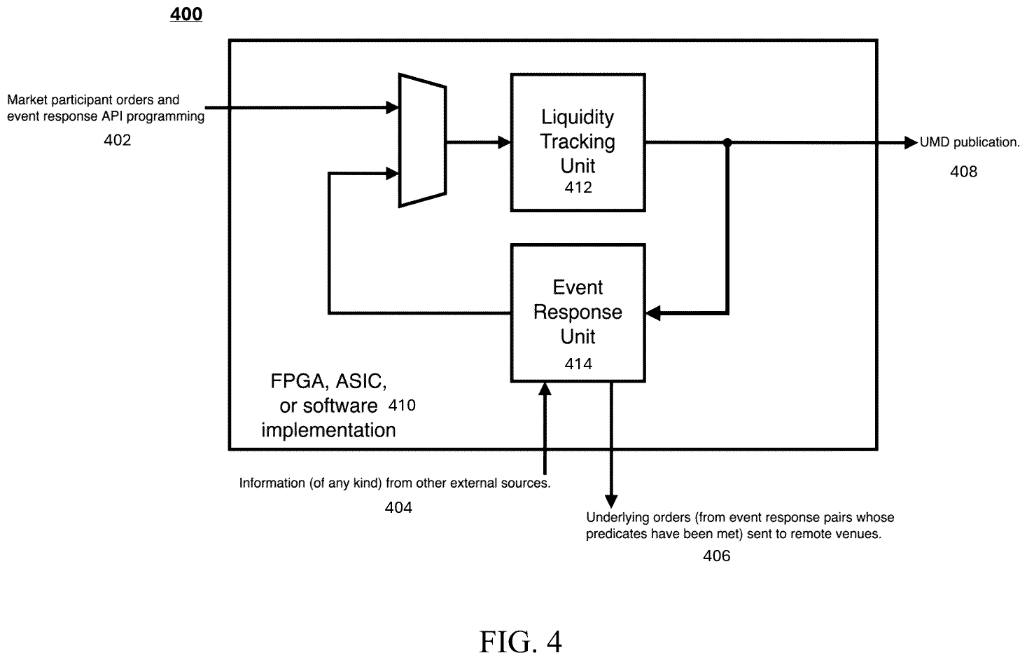

FIG. 4 depicts an illustrative system 400 for processing market participant orders and event responses. The system 400 for processing market participant orders and event responses may include multiple interfaces and processing modules that work together to handle market data and order processing.

The system 400 may receive inputs through two interfaces: a market participant interface 402 and an external information interface 404. The market participant interface 402 may handle orders and event response API programming. The external information interface 404 may receive information from other external sources. In some cases, the external information interface 404 may include data relevant to event response predicates.

The external information interface 404 may receive data from a diverse range of external sources that may influence trading decisions and trigger event responses. In some cases, these sources may include remote trading venues and exchanges that provide real-time market data, order book updates, and execution information from different geographic regions or asset classes. The interface 404 may also connect to news feeds and financial information services that deliver breaking news, earnings announcements, regulatory updates, and other market-moving events. Additionally, the external information interface 404 may receive data from government sources such as economic indicators, employment statistics, inflation reports, and central bank announcements that may impact market conditions. In some aspects, the interface may incorporate alternative data sources including weather reports that may affect commodity prices, satellite imagery for agricultural or energy markets, social media sentiment analysis, and other non-traditional information sources. The system may also receive data from blockchain networks, decentralized finance protocols, and cryptocurrency exchanges to support cross-venue arbitrage opportunities. Furthermore, the external information interface 404 may connect to third-party analytics providers, research services, and algorithmic trading signals that may serve as triggers for automated trading strategies across multiple venues.

A processing implementation 410 may process the incoming data and may contain two specialized modules: a liquidity tracking module 412 and an event response module 414. The liquidity tracking module 412 may monitor and track local or remote market liquidity. The event response module 414 may process event responses based on the received information.

The liquidity tracking module 412 may maintain real-time records of available liquidity across multiple venues, tracking order book depth, price levels, and volume at each level. It may continuously update these records as market conditions change, enabling the system to make informed decisions about order routing and execution. The liquidity tracking module 412 may also analyze historical liquidity patterns to identify trends and optimize future order placement strategies. The liquidity tracking module may track the local market liquidity and provide data for the local market matching algorithm and data for local market event publications. The event response module 414 may evaluate incoming trigger information against stored event predicates, identifying matches that satisfy the conditions specified in the predicate fields. When matches are found, the event response module 414 may retrieve the associated underlying orders, prepare them for transmission according to venue-specific protocols, and apply the multi-response handling algorithm to determine transmission priority. The event response module 414 may also handle post-execution tasks such as logging completed transactions, updating the status of processed event response pairs, and generating the data needed for unified market structure enriched market data messages.

Inter-venue event responses may be programmed by different market participants. It may be anticipated that receipt of one certain market relevant information, datum, or data may trigger or meet several predicates from several different clients or participants. In such a situation, each participant or client expects that their underlying order is sent to the eventual remote venue or destination. It may happen that several such underlying orders target the same desired trade or effect. In this scenario, each client or participant may desire that their underlying order be sent first.

The system 400 may utilize a multi-response handling algorithm for managing the order in which event pairs are responded to when multiple event pairs are satisfied. The multi-response handling algorithm may implement various approaches. In some cases, the algorithm may use sequential multi-response, where orders are sent one-by-one. In other cases, the algorithm may use pro-rata split and interleave multi-response, where orders are split into smaller orders and interleaved. The algorithm may also use pro-rata aggregation, where orders are aggregated and sent on behalf of multiple participants.

If, for a multi-response scenario, each underlying order is sent one-by-one, the order or sequence in which the multiple underlying orders, each responding on the same basis, is sent may be based on one of several schemes, including but not limited to: the time at which the event-response programming arrived at the inter-venue event-response technology implementation, randomly, or according to a business relationship established by the event-response technology provider with the client.

Should the multi-response one-by-one sending sequence be randomized amongst clients, it may be expected that, over time, each participant or client shares the “first” or “front of queue” position as long as they are participating in such multi-response events on a regular basis.

In a multi-response scenario, the underlying orders may split into smaller orders, and then interleaved according to some scheme. For example, if underlying orders typically target quantities of greater than a threshold unit of traded quantity (e.g., 100 shares), then the individual underlying orders may be split into smaller orders (e.g. sent with a quantity of 10) and the various orders may be sent according to some interleaving scheme such that each client or participant has their entire order sent but also interleaved with the sending of the other market participant or client orders.

This method of splitting apart and reconstituting an original order may not be feasible according to certain venue protocols. For example, if the destination venue to which the underlying order will be sent requires that its incoming messages or orders be cryptographically signed and the private key for the client or participant is not shared with the inter-venue event-response host, then it is not possible to split apart an underlying order because the cryptographic signature would be invalidated by altering the underlying order content.

On behalf of its participants or clients, the inter-venue event response host may aggregate together orders that respond on the same basis. For example, if multiple clients program event-responses that send to a remote venue attempting to buy a certain asset at a certain price all on the basis of the same predicate, then the event response host may aggregate together those orders and send the order on its own behalf or on behalf of a proxy market participant. After the order is sent and filled or partially filled, the event-response host is responsible for apportioning the filled quantity to the participants according to their requested participation. The pro-rata sharing may be apportioned according to a multiplicity of schemes including, without limitation, random allotment in fixed size quantities and allotment according to a business arrangement between the inter-venue event response host and its clients.

The processing implementation 410 may log execution of event response pairs. In some cases, the processing implementation 410 may modify stored event response pairs to remove or update processed event responses.

The system 400 may include two output interfaces: a remote venue interface 406 and a market data publication interface 408. The remote venue interface 406 may transmit underlying orders from event response pairs whose predicates have been met to remote venues.

The market data publication interface 408 may publish system events. In some embodiments, these publications may be in the form of unified market structure enriched market data (UMD) publication. The processing implementation 410 may generate and publish UMD messages through the interface. These UMD publications may combine book and trade publication into one publication. In some cases, UMD publication may be triggered by various criteria, such as receipt of an individual order or by each individual book level that an order interacts with.

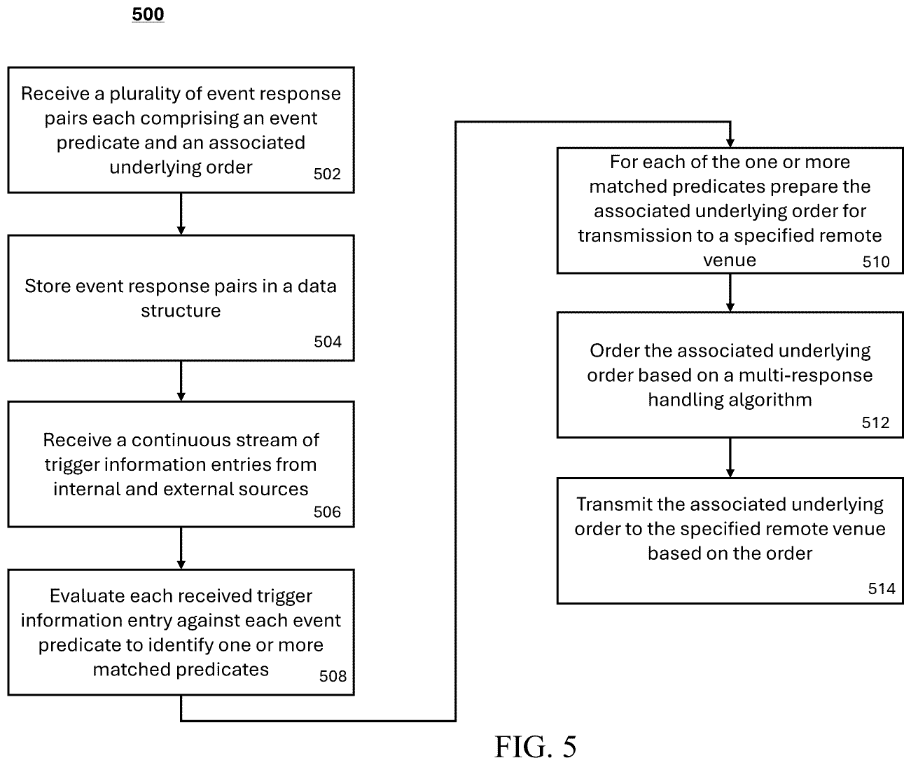

FIG. 5 illustrates a flowchart of a method 500 for processing event response pairs and transmitting orders. The method 500 may include multiple steps for handling event response pairs and managing order transmission.

A step 502 may include receiving (e.g., via interface 302) a plurality of event response pairs. Each event response pair may comprise an event predicate and an associated underlying order. In some cases, the event predicate may include information related to one or more of the trigger asset field 202, the event type field 204, the event book side field 206, the minimum price field 208, the maximum price field 210, the minimum quantity field 212, and the maximum quantity field 214.

A step 504 may include storing the event response pairs in a data structure. The data structure may be implemented in the memory of the system 400.

A step 506 may include receiving a continuous stream of trigger information entries from internal and external sources. In some cases, these sources may include the market participant interface 402 and the external information interface 404.

A step 508 may include evaluating each received trigger information entry against each event predicate to identify one or more matched predicates. The processing implementation 410 may perform this evaluation.

A step 510 may include preparing the associated underlying order for transmission to a specified remote venue for each of the one or more matched predicates. In some cases, the specified remote venue may comprise a trading venue.

A step 512 may include ordering the associated underlying order based on a multi-response handling algorithm. The multi-response handling algorithm may prioritize orders based on at least one of: time of predicate match, order size, or price parameters.

In some cases, the multi-response handling algorithm may include a payment-based prioritization system. For example, participants may bid for queue position, with higher bidders receiving earlier transmission slots. In some aspects, the multi-response handling algorithm may consider subscription tier levels, where premium subscribers or participants with higher service agreements may receive priority over standard participants. The system may also implement a volume-based prioritization approach, where participants with higher historical trading volumes and/or larger committed order flows may receive preferential sequencing. Additionally, the multi-response handling algorithm may incorporate market maker privileges, where designated market makers or liquidity providers may receive priority to support market stability and liquidity provision. In some cases, the algorithm may utilize a credit rating or risk assessment system, where participants with better credit profiles or lower risk scores may receive priority treatment in order transmission sequences.

The method 500 may include applying cryptographic signatures to the underlying orders before transmission. In some cases, the cryptographic signature process may involve generating a digital signature using private key cryptography to authenticate the order and verify its integrity during transmission. The system may apply cryptographic hash functions to create a unique fingerprint of the order data, which may then be encrypted using the sender's private key to produce the digital signature. The cryptographic signatures may serve multiple purposes, including ensuring order authenticity by confirming that the order originated from an authorized source, maintaining data integrity by detecting any unauthorized modifications during transmission, and providing non-repudiation capabilities that prevent the sender from denying the submitted the order. In some aspects, the cryptographic signature process may utilize industry-standard algorithms such as RSA, ECDSA, or other public key cryptography methods to ensure compatibility with remote venue security requirements. The signed orders may include both the original order data and the cryptographic signature, allowing the receiving venue to verify the signature using the sender's public key and confirm that the order has not been tampered with during transmission.

A step 514 may include transmitting the associated underlying order to the specified remote venue based on the order. The remote venue interface 406 may handle this transmission.

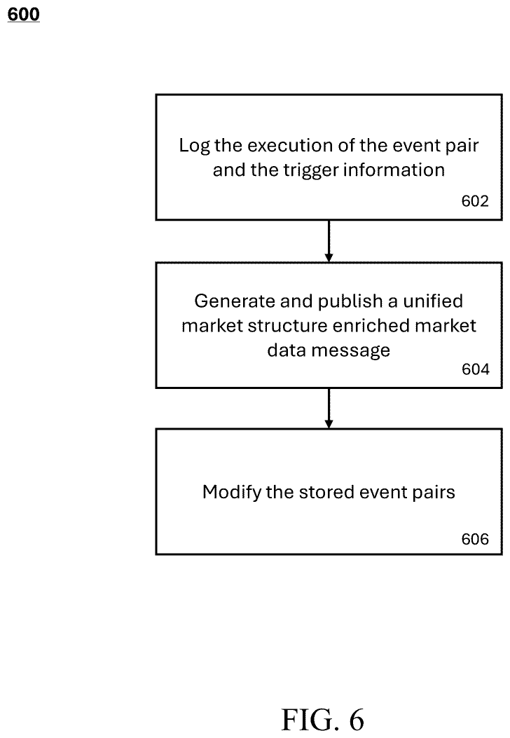

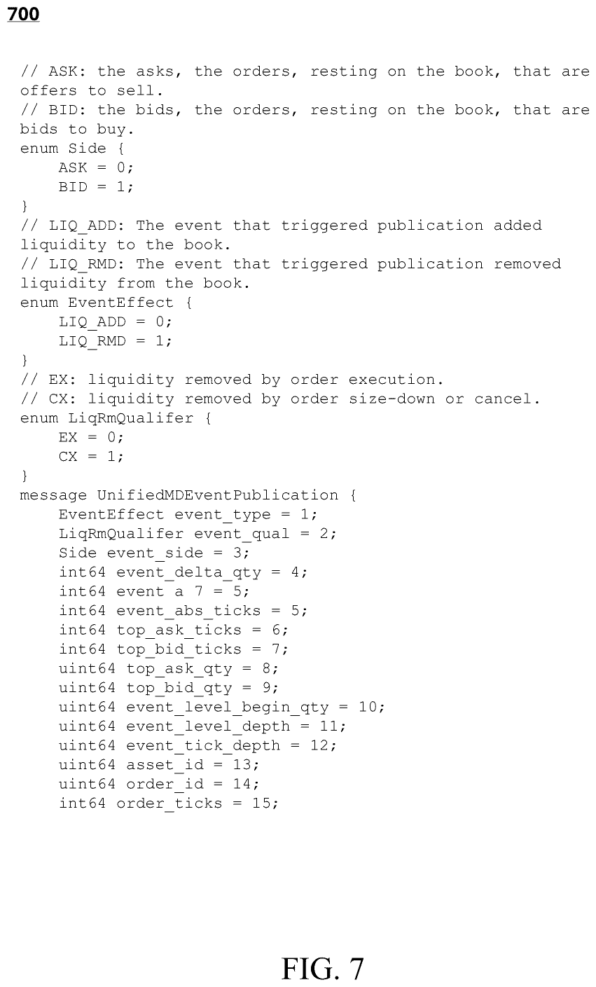

FIG. 6 illustrates a flowchart of a method 600 for post-processing market data and event pairs. The method 600 may include multiple steps for handling event pair execution, generating market data messages, and updating stored event pairs.

A step 602 may include logging the execution of the event pair, their components, and/or the trigger information. In some cases, the processing implementation 410 may perform this logging. The logging may include recording information about the event pair that was executed, such as the trigger asset field 202, the event type field 204, the event book side field 206, the minimum price field 208, the maximum price field 210, the minimum quantity field 212, and the maximum quantity field 214.

A step 604 may include generating and publishing a unified market structure enriched market data message. The market data publication interface 408 may handle this publication. In some cases, the unified market structure enriched market data message may combine book and trade publication into one publication. The message may include information about the underlying order that triggered the event pair execution, as well as its effect on the order book.

Various existing financial exchanges publish information about the market prices for various assets traded at their exchange and other information about the market state including, for example, information about the so-called order book and information about trades that have executed.

The order book may include all of the orders in-force at any given moment. Some exchanges provide an option to submit orders that are not published to participants, enabling so-called “hidden” limit orders, “non-published” or “dark” orders.

Thus, existing exchanges publish information to their participants or clients. Such information may be referred to as “market data.” Market data publication may include messages that describe the state of the market and messages that describe events that have transpired, for example, executed trades. Such messages may include the publication of: individual limit order (e.g., the targeted asset such as the stock ticker symbol, the order limit price, the order quantity, the order time-in-force, and other relevant order parameters), top-of-book messages (e.g., the price and aggregated quantity of the best bid, best offer, or both), depth-of-book messages (e.g., prices and aggregated quantities for various price levels that are inferior to the best bid or best offer), trade summary messages (e.g., the price or average price and total aggregate quantity involved in a trade or match event), multi-trade summary messages (e.g., the price or average price and total aggregate quantity involved in several match events such as a plurality of bids and a plurality of offers that have executed), order execution messages (e.g., the price and quantity involved in the match between two individual orders from a bid and offer that have met together in price to constitute a trade), various other indicative messages (e.g. auction data or futures inter-market pricing data), fill messages sent directly to participants involved in a trade, and various other messages sent directly to individual participants (e.g., a request for a firm-up).

Existing financial exchanges publish market data to their participants and clients to facilitate the trading algorithms or screen displays for the same. Because existing market data publication separates book and trade information into separate streams of publication, participants in receipt of message from one stream may attempt to infer information about a different stream of data (e.g. receipt of a trade message may imply a modification to book state).

A step 606 may include modifying the stored event pairs. In some cases, the processing implementation 410 may perform this modification. The modification may include removing executed event pairs or updating the parameters of existing event pairs based on market conditions or user preferences. This step may help maintain the relevance and efficiency of the stored event pairs.

The method 600 may be implemented as part of the system 400 for processing market participant orders and event responses. In some cases, the method 600 may be executed by the event response module 414 within the processing implementation 410.

Further disclosed herein are methods and systems for forms of market data publication. Unified market structure enriched market data publications may publish information about the underlying order (e.g., that triggered the publication) along with that order's effect on the order book, including whether the order added liquidity (i.e., added quantity for bid or offer) or removed liquidity (i.e., removed quantity for bid or offer by canceling or downsizing a pre-existing order or by interacting with an opposite side order or orders to form a trade or execution). Thus, the market data publication combines or unifies book and trade publication into one publication where traditional these information types are published in separate streams of publication.

For example, such a UMD message may be published in response to every order submitted to the exchange or may be published based on other criteria, such as one publication for every book level an order interacts. In another example, the UMD message may be published based on information received from an external source 404.

The data stream of UMD messages may be configured as a single publication feed that enables complete reconstruction of the entire system state. Each UMD message may contain sufficient information to capture the discrete market event and/or its comprehensive impact on the order book, allowing subscribers to maintain a complete view of market conditions without requiring multiple disparate data feeds. The system may publish UMD messages in chronological sequence for each received input from the market participant interface 402, each external information input from the external information interface 404, each underlying order transmitted through the remote venue interface 406, and each associated event response pair execution. In some cases, each UMD message may be timestamped with nanosecond or picosecond precision to enable precise temporal ordering and synchronization across all system events. The sequential publication of these timestamped messages may allow market participants to reconstruct not only the current state of the order book but also the complete historical progression of all market events, order executions, and system responses that led to the current state, providing a unified audit trail of all system activity.

A UMD may include, without limitation, in its informational fields data including: the underlying asset (e.g., the stock ticker symbol, other stock identifier, the option contract identifier, the future contract identifier, the cryptographic currency or token identifier, or other identifier of the tradable asset), order side (e.g., whether the order intends to buy or sell the asset), book side (e.g., the side of the book, bids or offers, that the order interacted with), limit price (e.g., the maximum price at which the order may transact if buying or the minimum price at which the order may transact if selling), book level depth (e.g., the depth relative to the best price offered by existing orders on the book), book tick depth (e.g., the difference in price between the order limit price and the top-of-book best price, expressed in ticks), adds or removes liquidity indicator (e.g., indicating that the order adds liquidity, then the order added quantity available for bid or offer, to the book or indicating that the order removed liquidity, then quantity is removed from the book level indicated by book level depth and/or limit price), liquidity removed by execution or by cancel/size-down indicator (e.g., indicating that the order removed liquidity, then this indicator may indicate whether the order interacted or matched with a contra-sided order to form a trade or execution, and/or whether the order removed liquidity by cancelling or sizing down a preexisting resting order), top ask and/or top offer price (e.g., the best published price, for the asset, on the asks or offers), top ask and/or top offer quantity (e.g., the aggregate quantity published as available to transact at the best price on the bids or offers), indicator for new level formed (e.g., a binary value set toggled if the event or underlying order that caused publication created a new price level on either side of the book), indicator for level removed (e.g., a binary value set toggled if the event or underlying order that caused publication removed a price level from either side of the book), event level delta quantity (e.g., the change in quantity on the price level that corresponds to the order price), event level begin or end quantity (e.g., the total aggregate quantity for bid or offer on the book level and side corresponding the order price either before or after the effect of the order is integrated to the book).

The limit price may be expressed in various formats including binary twos complement encoded fixed point, floating point (e.g. IEEE standard single or double precision), string, or as an integer scaled to the underlying tick increment offered by the exchange for that asset (e.g. if the tick size is one penny, then the price is expressed as an integer value of pennies so a price of 100 ticks would be $1.00).

As an example, a level depth (e.g., indexed from zero) of 3 indicates that three other price levels of orders were already in-force and on-the-book that had better prices (i.e., higher limit prices for orders to buy and lower limit prices for orders to sell) than this order. A book level depth, indexed from zero, of zero may indicate that the limit price was at the best price for the relevant side (bids or offers) of the book.

In some embodiments, a tick depth of 4 indicates that the order price is 4 ticks deeper than the best price on the book but does not indicate that 4 other levels exist between the order and top-of-book. A tick depth of zero indicates that the order limit price was at the best price for the relevant book side (i.e., bids or offers).

In certain embodiments, various data in the UMD message may indicate events of interest to traders. For example, when a new price level is formed, that fact may be indicated by a specific flag or bit being set (e.g. the “new level” bit or flag) or by a certain quantity such as “event level begin quantity” (which would in this case have a value of zero because the level did not exist prior to the event being published).

Succinctly, a unified market structure enriched market data publication combines publication of a discrete market event (e.g. a new order or order modification) and its impact or effect on the market state (e.g. change in book state including beginning or final book state, and/or whether or not the order crossed into the contra book side to constitute a trade or order execution). The enumerated information fields are exemplary only. Furthermore, the enumerated information fields are potentially redundant in their information content, for example: book side, order side, and an indicator for liquidity removed by order execution may encode information redundantly (e.g. one may be able to infer an order execution if book side and order side are opposite). An embodiment of unified market structure enriched market data publication may implement such redundant information fields (e.g. for clarity or subscriber utility), or may not implement redundant information fields.

Publication of a UMD may be triggered by various criteria. For example, the publication may be triggered by receipt of an individual order, or by each individual book level that that order interacts with (e.g. if order crosses the spread with a deep enough price and large enough quantity to interact with several contra-sided price levels, one UMD may be published for each of those price levels so modified). Further, UMD data may be aggregated across several received orders or may not be published if a received order is marked as “hidden” or “not displayed.” Further, if the originating order is marked as “partially hidden” or “partially displayed” then the UMD, when published, may include or publish only the “display quantity” of the partially hidden order.

In some embodiments where exactly one and only one UMD is published for each displayed or partially displayed order received by the venue, the UMD publication format may be modified to accommodate orders that interact or sweep through multiple price levels. For example, the UMD publication may include a field to indicate the total aggregate quantity removed and a field to indicate begin and/or end quantity on the deepest level interacted with. In this embodiment, the UMD field for event level depth may indicate the level depth of the deepest level interacted with. For example, if an order sweeps through and completely removes three contra-sided price levels (e.g., with aggregate quantity of 250 in those three levels) and executes 10 quantity in the deepest (e.g., fourth deep) contra-sided price level, the various relevant UMD fields may be extended and populated as in illustrated in the following example: {event type: LIQ RMD, event qual: EX, event level depth: 4, event delta qty: 260, level delta qty: 10}. Here, the “EX” qualifier along with a non-zero event level depth together indicate a multi-level order execution event. The event delta quantity and level delta quantity distinguish the total quantity transacted from the quantity transacted on the deepest and final remaining price level.

UMD publications may simplify reconstructing order book state for market participants. Clients or market participants may use such UMD publications to reconstruct published order book state and to be notified about published trades and/or executions. Thus, a UMD publication feed may, according to the examples given above, be constructed or designed such that its contents are sufficient to construct or reconstruct the published state of the exchange order book. In an embodiment, the exchange or UMD publisher may also utilize or provide a second message type or feed that supplements the UMD data with periodic publications or snapshots of the entire book state. This full book state, inclusive of all order book levels, may also be integrated into the UMD publication message at the potential cost of increasing UMD message size. Clients or market participants that subscribe to exchange data during a trading session, as compared to subscribing before the session starts, may desire such additional “snapshot” or “full book state” messages so that they can populate their view of book data and then use the UMD messages to modify their view of the book as the market evolves or processes orders. To enable or support this, the UMD publication message and the snapshot, deep book, or full book message may use a sequence number, a timestamp, or other information to indicate alignment or synchronization between the UMD or snapshot book message. Such aligning or sequencing information may be included in a UMD message regardless of its utility or perceived necessity toward synchronization with other message publication streams.

### Example UMD Publication Message

FIG. 7 depicts an example unified market structure enriched market data message 700 in accordance with an embodiment. The message 700 may define several enumerated types that provide standardized values for market data publication. A Side enumeration may include ASK and BID values, where ASK may represent orders resting on the book that are offers to sell, and BID may represent orders resting on the book that are bids to buy. An Event Effect enumeration may include added and removed liquidity values that may indicate an event that triggered publication added liquidity to the boo or an event that triggered publication removed liquidity from the book. A liquidity removal qualifier enumeration may include values for liquidity removed by order execution and liquidity removed by order size-down or cancel.

The message 700 may also define a publication message structure that contains multiple fields for comprehensive market data publication. These fields may include event type, event qualifier, event side, event delta quantity, event absolute ticks, top ask ticks, top bid ticks, top ask quantity, top bid quantity, event level begin quantity, event level depth, event tick depth, asset identifier, order identifier, and order ticks. The message structure may enable the publication of both book modifications and trade information in a single unified format. In some cases, the unified market structure enriched market data message may be generated by the processing implementation 410 and published through the market data publication interface 408, allowing market participants to receive consolidated information about order book changes, trade executions, and market state updates.

The UMD message may be implemented using Protocol Buffers (protobuf) format as illustrated, which may provide efficient serialization and cross-platform compatibility for high-frequency market data transmission. In some cases, alternative message formats may also be considered including, but not limited to, JavaScript Object Notation (JSON) for human-readable data interchange, Apache Avro for schema evolution capabilities, MessagePack for compact binary serialization, or custom binary formats optimized for specific latency requirements. The choice of message format may depend on factors such as performance requirements, interoperability needs, schema flexibility, and existing infrastructure compatibility within the trading environment.

### Example Inter-Venue Trade

For sake of example, consider two hypothetical financial exchanges named “AX” and “BX.” Both “AX” and “BX” offer trading in shares of “ABC,” a fictional stock ticker for a fictional publicly traded company stock. In this contrived example, we purposefully do not consider the effect of any specific regulatory regime, e.g. and in specific, we ignore the effect of the U.S. NMS trade-through protection rule and related regulations.

In our example, suppose that, on average, AX handles 90% of the daily volume for ABC shares traded and BX handles 10% of the volume. Thus, traders have formed the opinion that a price change at venue AX implies consensus, that is to say, that prices offered and bid for at AX are more stable than prices bid for or offered at BX. In our example, AX will be the “local venue” and BX the “remote.”

Suppose that at some moment in time (to), AX and BX have displayed the following bids and offers for shares of ABC:
AX & BX top-of-book state at time=t₀.

| Exchange | Bid | Offer |
|---|---|---|
| AX | 500 @ $99.99 | 200 @ $100.00 |
| BX | 200 @ $99.99 | 100 @ $100.00 |

Now suppose that at a buyer enters the market at AX and places an order to buy 200 shares of ABC for $100.00 per share and AX publishes this information at time t₁. Other traders may respond to this information by submitting orders to BX to buy shares of ABC at $100.00 per share.

Further, suppose that a trader, at AX, places a new resting quote that is an offer to buy shares of ABC at $100.01 per share and that AX publishes this information at time t₂. Other traders may respond to this information by submitting orders to BX to buy shares of ABC at $100.00 per share.

Here, we show the hypothetical top-of-book bids and offers at AX and BX at times t₁ and t₂, with prices and quantities consistent with the description above:
AX & BX top-of-book state at time=t₁.

| Exchange | Bid | Offer |
|---|---|---|
| AX | 500 @ $99.99 | 400 @ $100.02 |
| BX | 200 @ $99.99 | 100 @ $100.00 |

AX & BX top-of-book state at time=t₂.

| Exchange | Bid | Offer |
|---|---|---|
| AX | 150 @ $100.01 | 400 @ $100.02 |
| BX | 200 @ $99.99 | 100 @ $100.00 |

At time t₂, the bid at AX is improved from $99.99 to $100.01. In particular, note that at time t₂, that according to the displayed quotes, one can buy shares for $100.00 (at BX) and sell for $100.01 (at AX). This is the “arbitrage” trade, wherein if successful in taking both quotes (the offer at BX and the bid at AX) then one realizes a low-risk profitable trade.

Similar inter-venue trading opportunities arise in many contexts. In certain regulatory contexts (e.g., within the U.S. equities National Markets System) such trades may be effectively prohibited for fungible assets, but available for highly correlated assets. In other contexts, for example in cryptographic currencies, fiat currencies that trade on multiple global venues, or between cash settled future contracts on an index and an exchange-traded fund (ETF) whose underlying basket of assets comprises the index, such inter-venue opportunities are common.

In the example, traders may respond at time t₁ (i.e., when shares of ABC were bought at AX) or at t₂ (i.e., when, at AX, a new price level, of offers to buy at $100.01 per share, was formed). Succinctly, in response to information published by AX traders may submit orders to venue BX.

### Example Computing System

FIG. 8 illustrates a block diagram of a computing system 800 that may be used to implement the event response system described in previous sections. The computing system 800 may include various components that work together to process event response pairs, evaluate trigger information, and transmit underlying orders.

The computing system 800 may include a processor 810. The processor 810 may be implemented as various types of processing units, including a central processing unit (CPU), graphics processing unit (GPU), tensor processing unit (TPU), field-programmable gate array (FPGA), application-specific integrated circuit (ASIC), or other specialized processing hardware. In some cases, the processor 810 may comprise a combination of multiple processing units working in parallel to handle the high-frequency data processing requirements of the event response system.

The processor 810 may execute instructions stored in a memory 822 to perform various operations of the event response system. These operations may include preparing associated underlying orders for transmission, modifying stored event response pairs to remove or update processed event responses, and evaluating trigger information entries against event predicates.

A system bus 812 may provide a communication pathway between the processor 810 and other components of the computing system 800. The system bus 812 may allow the processor 810 to access data and instructions stored in the memory 822, as well as communicate with peripheral devices.

A user interface 814 may allow users to interact with the computing system 800. The user interface 814 may include input devices such as keyboards or mice, enabling users to input event response pairs or modify system settings.

A display device 818 may provide visual output for the computing system 800. The display device 818 may show information such as market data, event response pair status, or system performance metrics.

A network device 820 may enable the computing system 800 to communicate with external systems and networks. The network device 820 may receive trigger information entries from external sources and transmit underlying orders to specified remote destinations, such as remote venues. In some embodiments, the network device 820 may allow the computing system 800 to communicate with other computing systems for distributed processing.

The memory 822 may store instructions and data for the event response system. The memory 822 may contain event response pairs, trigger information entries, and other data necessary for system operation. The processor 810 may access the memory 822 to retrieve and store information as needed.

In some cases, the computing system 800 may implement the method 500 for processing event response pairs and transmitting orders. The processor 810 may execute instructions stored in the memory 822 to perform the steps of the method 500, including receiving event response pairs, evaluating trigger information entries, and transmitting underlying orders.

The computing system 800 may also implement the method 600 for post-processing market data and event pairs. The processor 810 may execute instructions to log execution of event response pairs, generate and publish unified market structure enriched market data messages, and modify stored event pairs.

The processor 810 may sequence underlying orders based on a multi-response handling algorithm. This algorithm may be stored in the memory 822 and executed by the processor 810 to prioritize order transmission.

The computing system 800 may utilize the market participant interface 402 and the external information interface 404 to receive input data. The remote venue interface 406 and the market data publication interface 408 may be implemented through the network device 820 to transmit orders and publish market data.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure as come within known or customary practice in the art to which these teachings pertain.

As used in this document, the singular forms “a,” “an,” and “the” include plural references unless the context clearly dictates otherwise. Those having skill in the art can also translate from the plural form to the singular as is appropriate to the context and/or application. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices also can “consist essentially of” or “consist of” the various components and steps, and such terminology should be interpreted as defining essentially closed-member groups.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is also to be understood that the terminology used herein is for the purpose of describing particular embodiments only and is not intended to be limiting.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed:

1. A system comprising:
a memory configured to store a plurality of event response pairs, each event response pair comprising an event predicate and an associated underlying order;
a network interface configured to receive a continuous stream of trigger information entries from internal and external network sources; and
a processor communicatively coupled to the memory and the network interface, the processor configured to:
evaluate each received trigger information entry against each event predicate to identify one or more matched predicates,
for each of the one or more matched predicates, prepare the associated underlying order for transmission over a network to a specified destination,
if multiple different responses are triggered simultaneously, sequence the associated underlying order based on a multi-response handling algorithm for network transmission, and
transmit, via the network interface, the associated underlying order to the specified destination based on the sequence.

2. The system of claim 1, wherein each event predicate comprises a trigger asset field and one more additional fields comprising at least one of: an event type field, an event book side field, a minimum price field, a maximum price field, a minimum quantity field, a maximum quantity field, and an operation code field comprising programming instructions.

3. The system of claim 1, wherein the processor is further configured to generate and publish a unified market structure enriched market data message, wherein the unified market structure enriched market data message combines book updates and trade publication into a single publication.

4. The system of claim 3, wherein the unified market structure enriched market data message further combines new orders, order modifications, order cancellations, and top-of-book information.

5. The system of claim 3, wherein publishing the unified market structure enriched market data message comprises publishing to a single data stream configured to recreate a complete system-state based on a prior snapshot system-state.

6. The system of claim 1, wherein the processor is further configured to modify the stored event response pairs to remove or update processed event responses.

7. The system of claim 1, wherein the multi-response handling algorithm prioritizes orders based on at least one of: time of predicate match, order size, or price parameters.

8. The system of claim 1, wherein the multi-response handling algorithm comprises payment-based prioritization.

9. The system of claim 1, wherein the specified destination comprises a trading venue.

10. A method comprising:
storing, by a processor, a plurality of event response pairs, each event response pair comprising an event predicate and an associated underlying order;
receiving, by the processor, a continuous stream of trigger information entries from internal and external network sources;
evaluating, by the processor, each received trigger information entry against each event predicate to identify one or more matched predicates;
for each of the one or more matched predicates, preparing, by the processor, the associated underlying order for transmission over a network to a specified destination;
if multiple different responses are triggered simultaneously, sequencing, by the processor, the associated underlying order based on a multi-response handling algorithm for network transmission; and
transmitting, via the network interface, the associated underlying order to the specified destination based on the sequence.

11. The method of claim 10, wherein each event predicate comprises a trigger asset field and one more additional fields comprising at least one of: an event type field, an event book side field, a minimum price field, a maximum price field, a minimum quantity field, a maximum quantity field, and an operation code field comprising programming instructions.

12. The method of claim 10, further comprising generating and publishing a unified market structure enriched market data message, wherein the unified market structure enriched market data message combines book updates and trade publication into a single publication.

13. The method of claim 12, wherein the unified market structure enriched market data message further combines new orders, order modifications, order cancellations, and top-of-book information.

14. The method of claim 12, wherein publishing the unified market structure enriched market data message comprises publishing to a single data stream configured to recreate a complete system-state based on a prior snapshot system-state.

15. The method of claim 10, further comprising modifying the stored event response pairs to remove or update processed event responses.

16. The method of claim 10, wherein the multi-response handling algorithm prioritizes orders based on at least one of: time of predicate match, order size, or price parameters.

17. The method of claim 10, wherein the multi-response handling algorithm comprises payment-based prioritization.

18. The method of claim 10, wherein the specified destination comprises a trading venue.

19. A non-transitory computer-readable medium storing instructions that, when executed by a processor, cause the processor to perform operations comprising:
storing a plurality of event response pairs, each event response pair comprising an event predicate and an associated underlying order;
receiving a continuous stream of trigger information entries from internal and external network sources;
evaluating each received trigger information entry against each event predicate to identify one or more matched predicates;
for each of the one or more matched predicates, preparing the associated underlying order for transmission over a network to a specified destination;
if multiple different responses are triggered simultaneously, sequencing the associated underlying order based on a multi-response handling algorithm for network transmission; and
transmitting the associated underlying order to the specified destination based on the sequence.

20. The non-transitory computer-readable medium of claim 19, wherein the operations further comprise generating and publishing a unified market structure enriched market data message, wherein the unified market structure enriched market data message combines book updates and trade publication into a single publication.
